(19) United States
(12) Patent Application Publication
(10) Pub. No.: US 2017/0358135 A1
(43) Pub. Date: Dec. 14, 2017

(54) Augmenting the Half-Mirror to Display Additional Information in Retail Environments

(71) Applicant: Rajiv Trehan, Bangkok (TH)

(72) Inventor: Rajiv Trehan, Bangkok (TH)

(21) Appl. No.: 15/178,524

(22) Filed: Jun. 9, 2016

(51) Int. Cl. G06T 19/00; G06Q 30/06; H04N 5/232; G06F 3/01

(52) U.S. Cl. CPC G06T 19/006; G06F 3/013; G06Q 30/0623; H04N 5/232

(57) ABSTRACT

A system and method that recognizes a product or object of interest being viewed in a retail store and augments the reflection on a half-mirror display system with additional information associated to the product or object of interest. The half-mirror display system includes a half-mirror, one or more cameras, a recognition terminal, a processor and a monitor display. The method of augmenting reflection on the half-mirror display system includes; capturing a stream of images of the product or object of interest from one or more cameras installed at the rear of the half-mirror, recognizing the product or object of interests and product orientations in the stream of images by the recognition terminal, augmenting the reflection with Meta-data of a product or object of interest in real time, and displaying the Meta-data of the product or object of interest on the monitor display.

### FIELD OF THE INVENTION

The present invention relates to augmentation of reflection on a half-mirror display system and, more particularly, to a half-mirror display system for recognizing a product or object of interest and simultaneously augmenting the reflection with additional information associated to the product or object of interest.

### BACKGROUND OF THE INVENTION

At present in major retail stores, a customer enters a store, browses through several products available for sale, selects one of the products that they are interested in, and tries that product on in a fitting room (e.g., in the case of apparel such as shirts, pants, coats and other garments, as well as shoes, glasses, and/or any other products). The customer generally relies upon a sales associate to provide further information about the products in the store such as available clothing sizes, accessories, feedback and suggestions related to the products.

Prior to making a decision which product to buy a customer may try on various products and may view for each trial in front of a mirror at a trial area of the retail store. For example, the customer may try on a first product, e.g., a shirt, and view for the appearance in front of the mirror. Then, the customer may try on a second product, e.g., another shirt. The customer may then need to memorize his/her appearance from the first trial in order to perform comparison between the first product and the second product, thereby to evaluate which of the two products might be a better fit for the customer.

Unfortunately, since the customer may try on numerous products and/or since these trials may take a considerable amount of time, the customer may not be able to recall his/her appearance for each trial and may therefore be required to repeatedly retry. Also, a customer relies upon a sales associate to provide further information about each product after each trial or before trials in the store. This may result in a frustrating and inefficient shopping experience.

In the retail business, the cost of operating a physical store is high. It is desirable for a store retailer to decrease the amount of operating cost for physical product inventory offering a large number of products for sale. Further, each consumer wants to know more about the products he/she is buying. It is desirable to present product information to the consumer as part of the journey within the store. Until now this information exchange is extremely dependent on the individual sales associate; combined with the help of any available digital media providing information on product. However, the actual information of describing each product is not conveniently delivered to the customer in real time for review.

Therefore, new technologies are appearing in the market that use digitally captured images of a product as the basis for identifying featured objects within the images. Identifications of the featured objects enable precise and specific object information characteristics to be retrieved from various databases and presented in real-time; convenient for the user. In such circumstances, it is contemplated that computer analysis of the captured images could be performed locally (i.e. on the cell phone, PDA or other device capturing the image), distally at a server, or more preferably using some combination of the two.

Furthermore, the conventional mirror is currently used as the most reliable tool for an individual to explore self-appearance, in real time. Some technical alternatives have been proposed, based around the combination of a camera and a screen to replace the conventional mirror. However, these technical approaches are unconvincing and not yet accepted as a true reliable image of the individual as if they were looking at themselves in a conventional mirror. This variance is mainly due to the image generated by a camera, portraying significantly different highlights compared to an image generated by a mirror. Mirror images overload gracefully when features get too light or wash out. The mirror mimics our eye behavior better than digital. Digital's weak point is that highlights abruptly clip and look poor to a user as soon as any part of the image becomes white. The eye works with a mirror to allude the gradual overload to white. A Digital camera colour image characteristic curve heads straight to white, ungraduated. If any broad area like a forehead is overexposed as a highlight the facial image is poorly represented on a digital image. Thereafter, switching from mirror to video is usually accompanied by features that allow the video to be adjusted in some way, for example changing the colors of the items being considered. Furthermore, some magic mirror allows virtual clothing to be supper imposed to the video being displayed from example a virtual wardrobe.

When a customer looks in the mirror, they see a reversed reflection perpendicular to the mirror surface. There are other phenomena to note, regarding the reflection from a mirror compared to an image from a camera. For example, when the customer approaches the mirror, the reflection of their eyes will always stay on the same virtual line into the mirror. Conversely, depending on a camera's height and position, as the customer gets closer to the camera, the user's eyes may appear at different levels due to the effect of Parallax. Parallax is a displacement or difference in the apparent position of an object viewed along two different lines of sight, and is measured by the angle or semi-angle of inclination between those two lines.

Another difference from a camera is that when a user looks at a mirror, their image appears to be reversed (e.g., if user raises their right hand, the left hand will appear to go up in the mirror). As the image in the mirror is a virtual image, the mirror can be smaller than the full body and the user will still see the reflection of their full body.

For at least some of the reasons noted above, so far no digital visual capture and representation system has been designed to accurately reproduce the reflectional properties of a mirror. Achieving this digitally will have many visual applications in retail and other fields, and open the possibility of incorporating enhanced real life experiences with virtual life experiences, and sharing these on social networks using a variety of mobile and multi-media technologies.

A mirror incorporating information display functions have been designed. However, in the related art described above, the design envisages information display functions are implemented in combination with a half-mirror to display predetermined descriptive product or object information. To date full use of the images of the customer reflected in the proposed half-mirror design are not accurately made in existing full mirror digital visual display products.

An interactive system displaying personalized information using a combination of a half-mirror and an LCD display can provide augmented product information. The half-mirror can be used as a normal mirror when information is not being displayed. Replacing an existing mirror with the proposed system saves retail floor space by compacting product viewing with augmented information in a single display unit footprint. Personalized information can be displayed when a customer's face is recognized using a camera to identify the customer potentially allowing a previous or preferenced product profile to be retrieved. Moreover, on the half-mirror interactive display enables a customer to select products by finding and reviewing detailed product characteristics.

Companies such as The Big Space have used Magic Mirror display technology to enhance product brand experiences, such as with Mac makeup. Typical current display technology combines RFID-tagged products. The products pop up on a mirror while the customer is viewing them. The RFID provides detailed information about the product. Maintaining up to date product branding through RFID's is a significant overhead for the retailer and can be a significant outlay for a manufacturer with a product brand failure to sell.

So a more cost effective display system and information retrieval method are needed that allow consumers to obtain information of the products or objects of interest. The proposed system augments the product reflection on a half-mirror display system incorporating additional information of the product being shown.

### SUMMARY OF THE INVENTION

It is an object of the invention is to provide a system and method that recognizes a product or object of interest being viewed in a retail store and augment the reflection with additional information associated to the product or object of interest.

The present invention provides an augmenting a half-mirror display system. The system include a half-mirror, a monitor display; one or more cameras for capturing a stream of images of the products or objects of interests at the front of the half-mirror; a recognition terminal to detect products or objects of interests and product or object of interest's orientations in the stream of images; a processor to augment the reflection based on eye position of the viewer with Meta-data of products or objects of interests in real time, and a monitor display for displaying the Meta-data of the products or objects of interests. The half-mirror continues to function as a mirror and the monitor display displaying meta-data through the half-mirror and overriding the refection in part and thereby augmenting the reflection. To achieve the augmentation the areas of the refection that should not be augmented are black on the monitor display.

The camera is configured to capture a stream of images that include the user and the products or objects of interest are being shown in the half-mirror. The camera captures the stream of images in front of the half-mirror or in the proximity of the half-mirror, when the presence of a user is detected by a detection sensor or in the stream of the images.

The Meta-data includes detailed product information such as brand, a description of the product, a price, or a category of products.

The present invention provides a method for augmenting a half-mirror display system includes; operating the camera to capture a stream of images in front of the half-mirror, operating the recognition terminal to detect products or objects of interest and orientations of the products or objects of interest in the stream of images; operating the processor to augment reflection based on eye position and position of the user in the images, together with Meta-data of products or objects of interest in real time, and displaying the Meta-data of the products on the monitor display. During augmentation, the processor utilizes the different orientations of the images captured by the camera to present the Meta-data for each orientation and by also applies tracking of the eye position and position of the user.

### BRIEF DESCRIPTION OF THE DRAWINGS

The following invention will be described with reference to the following drawings of which:

FIG. 1 is a block diagram illustrates a half-mirror display system according to the present invention.

FIG. 2 is a flowchart illustrating a method for augmenting the half-mirror display system according to the present invention.

FIG. 3 depicts an exemplary methodology illustrating augmenting of a product in front of a half-mirror in one aspect of the invention.

FIG. 4 depicts another exemplary methodology illustrating augmenting of a product in front of half-mirror in one aspect of the invention.

The drawing figures do not limit the present invention to the specific embodiments disclosed and described herein. The drawings are not necessarily to scale; emphasis instead is placed upon clearly illustrating the principles of the invention.

### DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or in groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects of the present disclosure involve techniques for augmenting a half-mirror display system as part of an in-store retail shopping experience. As used herein, an “individual,” “consumer,” “customer,” or “user” may be used interchangeably and refer to a person (e.g., a human) utilizing the services described herein. As used herein, the term “retail store” refers to a physical retail store that sells various products to the public. Additionally, as used herein, the terms “objects of interest” or “items” or “products” refer to goods or services offered for sale at retail store.

In a preferred embodiment of the present invention is a method for augmenting a half-mirror display system. The half-mirror display system may include a half-mirror, one or more cameras, a recognition terminal, a processor and a monitor display. The method comprises: operating the camera to capture a stream of images from in front of the half-mirror; operating the recognition terminal to detect at least one product and orientations of the product in the stream of images; operating the processor to augment the reflection based on position of the product, eye position of the viewer with product Meta-data in real time; displaying the Meta-data of the product on the monitor display, wherein during augmentation, the processor utilizes the position of the product and the eye position of the viewer and adjust the position of the augmentation. The half-mirror continues to function as a mirror and the monitor display displaying meta-data through the half-mirror and overriding the refection in part and thereby augmenting the reflection. To achieve the augmentation the areas of the refection that should not be augmented are black on the monitor display.

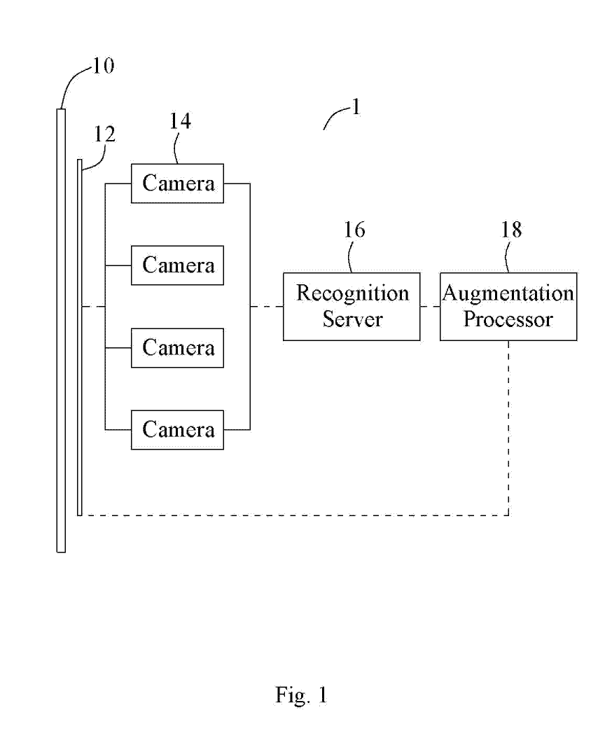

Referring to FIG. 1, a half-mirror display system 1 according to the present invention includes a half-mirror 10, one or more camera 14, a recognition terminal 16, a processor 18 and a monitor display 12. The half-mirror 10 reflects the image of the user or object from in front of the environment; one or more cameras 14 mounted above, below, behind or to the sides of the half-mirror 10 capture images of user or products or objects of interest. In order to augment the reflection of the products or objects of interest in the captured images, the images are sent into the recognition terminal 16. Wherein the camera 14 continuously sends captured images to the recognition terminal and a product or objects of interests in the images are then detected by the recognition terminal 16. Further, the processor 18, retrieves the Meta-data related to product or objects of interest in the images, augments the reflection of the products or objects of interest and is then displayed on monitor display 12. The recognition terminal 16 receives a stream of images from the camera 14, recognizes a products or objects of interest and orientations of the products or the objects of interest in the images. The augmentation with Meta-data resulting in an increased reality of the products or objects of interest displayed on a monitor display 12. The Monitor display 12 is placed rear of the half-mirror 10, the Meta-data related to the products or objects of interest is displayed, clearly visible through the half-mirror 10.

The eye position and position of a user is captured by a camera 14, the camera 14 may comprise an eye and a head orientation sensor, a position tracking sensor to identify a user position, and a feature analysis is performed on a recognition terminal 16. The camera 14 is mounted above, below or to the sides of the half-mirror 10 and captures a still or moving image of a user or products or objects of interest in front of the half-mirror 10. The recognition terminal 16 is configured to receive the captured image from the camera 14 and determine recognizes a products or objects of interest and orientations of the products or the objects of interest.

Further in an embodiment of the present invention is a method for augmenting a half-mirror display system. The half-mirror display system may include a half-mirror, one or more cameras, a recognition terminal, a processor and a monitor display. The method comprises: operating the camera to capture a stream of images from in front of the half-mirror; operating the recognition terminal to detect at least one product and orientations of the product in the stream of images; operating the processor to augment the reflection with product Meta-data in real time; displaying the Meta-data of the product on the monitor display, wherein during augmentation the monitor display is in display mode causes a half-mirror to function as a mirror thereby allowing augmented reflection of the product being shown on a monitor display.

One or more cameras 14 are mounted above, below, behind or to the sides of the half-mirror 10, for capturing an image on the mirror side and linked to the recognition terminal 16. The images are captured at regular intervals (every second or so). Wherein during idle mode, the camera 14 continuously sends captured images to the recognition terminal 16 and the products or objects of interest in the images are detected by the recognition terminal 16. Furthermore, in the images, the eye position of the user is determined and the user stationed near the half-mirror 10 or the presence of a user also can be determined by a sensor or may be by the camera 14. While an accurate real-time determination of eye position improves the augmentation effect, especially when dynamically adjusting the augmentation in real-time, in certain use cases and implementations a rough estimate of eye position would work well and better than no adjustment being made to the augmentation. For example, if the product recognised is a man's shoe then estimate of the eye position it could made by assuming the user is standing and on average is 175 cm tall, while for a child's shoe the height would be 110 cm tall.

In the context of a retail store, the recognition terminal 16 may be configured and updated specifically to recognize the products being sold in the retail store. This limits the recognition space of products or objects of interest and improves match accuracy. The reflection of a product or objects of interest is augmented in real time; the processor augments the reflection with Meta-data of products or objects of interest detected in the images.

Meta-data is pulled back based on identified product and product orientation. Meta-data may be general information, such as price or product name, or orientation specific information, such as heal or sole properties for running trainers.

It should be noted that for some orientations it may not be possible to recognize the products or objects of interest (for example soles on a running trainer may look very similar). It should be possible to determine a generic orientation and then differentiation by reference to the previous orientation recognized and hence gain the specific stock keeping unit (SKU) or store inventory. Thereby, augmentation of reflection using the appropriate Meta-data and angle.

Also, Meta-data is specifically about a part of the image captured and that may be highlighted in the live image by using arrow or lines on the display. To show the stable Meta-data on the product, the user position including eye position and the angle of the half-mirror may be calculated and adjusted on the monitor display 12. So, the reflection will be viewed differently from different angles but the meta-data will stay correctly positioned to the view and product orientation.

The augmentation of the reflection is adjusted according to position of the products or objects of interest and eye position of the viewer during augmentation and displayed accordingly on the monitor display 12. The Meta-data associated with the recognized products or objects of interest may include stock keeping unit (SKU), store inventory, related products. For optimization Meta-data may be held locally in the case of retail store or pulled in real time from a cloud based server. The server provides recommendation; the recommendation includes Meta-data describing one or more alternative matching products.

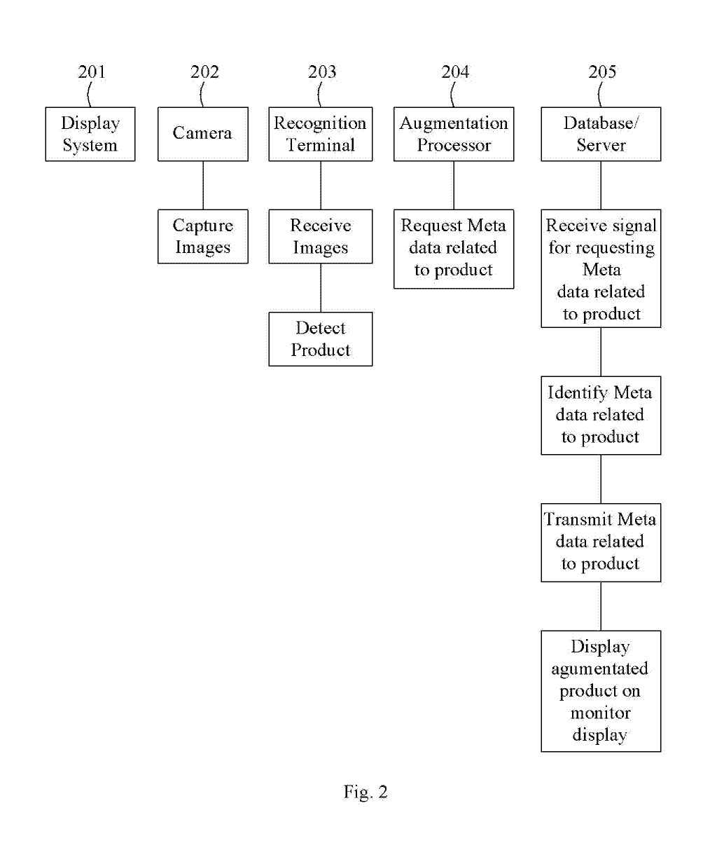

Referring to FIG. 2, in operation 201, is a display system for combining reflection of the products or objects of interest on the half-mirror 10 with additional information about products or objects of interest being displayed on to a monitor display 12, thereby augmenting the reflection. In operation 202 the plurality of camera 14 to capture a stream of images from in front of the half-mirror 10. In operation 203, a recognition terminal 16 identifies target products or objects of interest in the image captured, of a real-world environment. In operation 204, the recognition terminal 16 transmits a signal to request Meta-data related to the target products or objects of interest to a processor 18. The signal to request Meta-data related to the target products or objects of interest may include characteristic information related to the target products or objects of interest. The characteristic information may include Meta-data of detailed products or objects of interest information such as brand, a description of the product, a price, or a category of product, recommendations, social media trending of the product, brand asset endorsement, accessories. Characteristic information may also include marker-based product information including a Quick Response (QR) code. In operation 205, the database receives the transmitted signal from the processor requesting data related to the target products or objects of interest and; searches and identifies the Meta-data related to the target products or objects of interest corresponding to the transmitted signal in a database such as stock keeping unit (SKU) or store inventory. More specifically, the processor will search for product recognition information mapped to the characteristic information of the target products or objects of interest, which may be included in the transmitted signal requesting the Meta-data related to the target product or object of interest. Further in operation 205, the processor 18 then transmits the Meta-data related to the target products or objects of interest, to the corresponding display system and output for display on the monitor display 12.

Further, the processor 18 augments the reflection based on position of the products or objects of interest and eye position of the viewer with product Meta-data in real time; wherein during augmentation, the processor 18 utilizes the orientations of a products or objects of interest in the images captured by the camera 14 and also tracks user eye position, head position and position of the user. Wherein the monitor display 12 is in display mode and causes the half-mirror 10 to function as a mirror thereby allowing augmented reflection of the products being viewed on a monitor display 12.

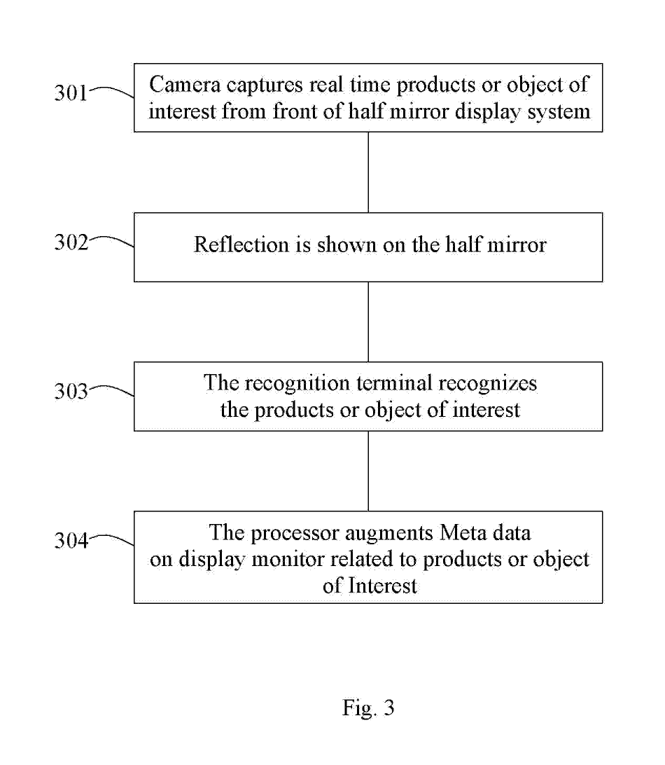

Referring to FIG. 3, it is to be understood and appreciated that the present invention is not limited by order of steps and that some of the steps may occur in different order and/or concurrently with other steps from that illustrated here. At step 301, one or more cameras 14 capture products or objects of interest in real time. Such cameras 14 are positioned above, below, behind or to the sides of the half-mirror 10. The Camera 14 captures the real-time products or objects of interest based on a manual or automatic trigger by a sensor, and the Camera 14 continually scans for products or objects of interest. At step 302, the reflection is shown on the half-mirror, where the Meta-data related to the products or objects of interest is displayed on the monitor display 12 by way of augmenting reflection. The monitor display 12 is an LCD (liquid crystal display) panel or an LED (light emitting diode) or an OLED (organic light emitting diode) display panel. At step 303, the recognition terminal 16 recognizes the products or objects of interest in the images in real time and transmits a signal to request Meta-data related of the products or objects of interest from the processor 18. At step 304, the Meta-data related to the products or objects of interest are instantly transmitted without on the monitor display 12.

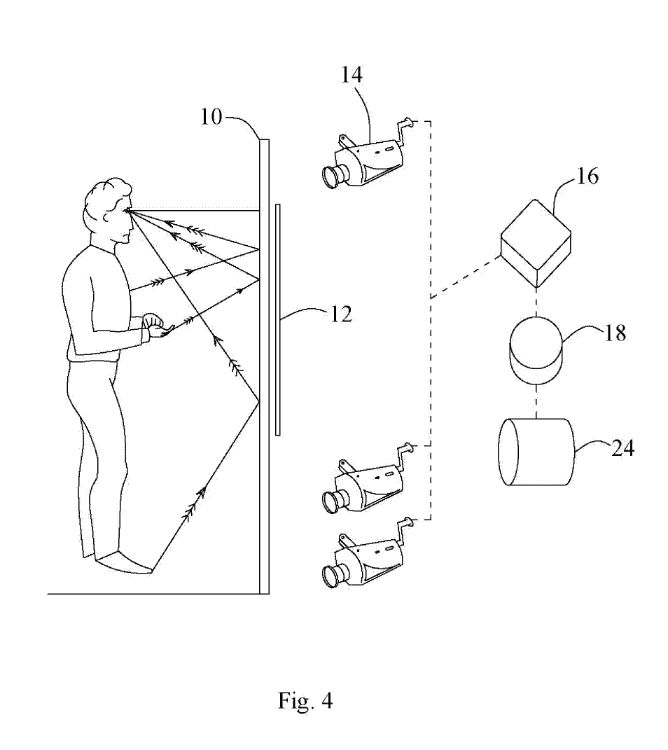

With reference to FIG. 4, this depicts one user is standing in front of half-mirror display system 1 at a retail store. The plurality of camera 14 suitably positioned to capture the real time view of a user or product. In a non-limiting embodiment of the present invention, the cameras 14 are a high definition camera. Preferably, half-mirror and monitor display 12 are positioned in the same plane representing a means for displaying and recording the superimposed augmented reflection. The Monitor display 12 may output or display augmented information. In an example, the Monitor display 12 may include a liquid crystal display (LCD) that can display images or text. The Monitor display 12 is behind of the half-mirror 10 and connected to the recognition terminal 16. The monitor display 12 may output or display information processed by the processor 18 from a local database 24 described above as the specific stock keeping unit (SKU) or store inventory.

The camera(s) 14 is connected to the recognition terminal 16. The recognition terminal 16 determines the product and product orientation. Each orientation may have a feature or specific related information, in the augmentation process determining position of the products or objects of interest and eye position of the viewer will also help the system to determine the best position on the reflection for displaying the additional information that can be seen by the user. The camera 14 is configured to capture a stream of images including the individual and the product or objects of interest from in front of the half-mirror 10.

Further, the recognition terminal 16 may continuously identify a product or object of interest in the image captured by the camera 14 in a continued scanning and in the event of scanning if a product or object or interest is identified, the augmentation process starts.

The recognition terminal 16 is communicatively configured to the processor 16 and the monitor display 12; the recognition terminal 16 may comprises: a detection module configured to detect a products or object of interest in the image captured by the camera 14; the detection module may further retrieve Meta-data that describes detailed product information from a product database, stock keeping unit (SKU) or store inventory for augmenting the reflection and a processor 18 is configured to generate the detailed information of product or object of interest to be presented on the monitor display 12.

The processor 18 may be a hardware processor to control the individual components described above, or a software module that may be executed in a hardware processor. The processor may include a recognition terminal 16 and a decoder.

The half-mirror 10 is a wall display and/or floor mirror, according to some example embodiments. The half-mirror may be designed such that it provides an aesthetic complement to the interior design of the retail store.

The half-mirror 10 is an electronic visual display that has two modes of operation. The first mode of operation is that of a mirrored surface that reflects an image. In some embodiments, the half-mirror display may include one or more layers that provide a naturally reflective surface, the camera 14 may be employed and configured such that the image feed captured from the camera is presented within the display to provide the mirrored reflection. While in the first mode of operation, the half-mirror 10 may appear to individuals as a common mirror such as those often employed in traditional retail fitting rooms. The second mode of operation is that of a display surface that is capable of presenting product and related Meta-data.

In the processor 18 is communicatively coupled to a database, which stores data such as stock keeping unit (SKU) or store inventory. The database may include a record of each uniquely identified product offered for sale by the retail store. Such records may include detailed information (e.g., a description, size, price, brand, style, fabric, and color) for each product. The database may include multiple databases that may be either internal or external to a networked retail store.

The half-mirror display system 1 may also include a recognition terminal module capable of identifying products offered for sale by the retail store to which the networked retail store system is connected.

Each product may be uniquely identified and tracked using the recognition terminal 16. Each product may be uniquely identified in the recognition terminal 16 using image processing and analysis techniques to automatically recognize products from images received from a camera 14.

The Meta-data could include recommendation module to provide recommendations for additional products or suggestions for alternative products from friends or social network. In some embodiments, the recommendation module may work in conjunction with previous products purchased by an individual, currently owned by the individual, products for which the individual has shown an interest or recommendation from other user connected on social networks.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. Accordingly, the term “hardware module” should be understood to encompass a tangible entity, be that an entity that is physically configured to operate in a certain manner and/or to perform certain operations described herein. The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such features may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

1. A method for augmenting a half-mirror display system, the half-mirror display system includes a half-mirror, one or more camera, a recognition terminal, a processor and a monitor display, the method comprising:
operating at least one camera to capture a stream of images from in front of the half-mirror, operating the recognition terminal to detect a product and product orientations in the stream of images;
operating the processor to augment reflection of the product in the half-mirror based on eye position and position of a user with Meta-data of the product in real time; and
displaying the Meta-data of the product on the monitor display,
wherein the half-mirror continues to function as a mirror and the monitor display displaying meta-data through the half-mirror and overriding the reflection in part and thereby augmenting the reflection.

2. The method of claim 1, wherein during idle mode the camera continuously sends the captured images to the recognition terminal, and the recognition terminal detects and recognizes the product in the images.

3. The method of claim 1, wherein the reflection of the product are augmented in real time.

4. The method of claim 1, wherein the processor is operating to augment the reflection with Meta-data of the product detected in the images.

5. The method of claim 1, wherein the images are adjusted according to eye position and position of the viewer during augmentation of the reflection.

6. The method of claim 1, further comprising operating the processor to access the Meta-data of the product from a stock keeping unit (SKU) or store inventory, the stock keeping unit (SKU) or store inventory is present locally in a retail store or over a network.

7. A method for augmenting a half-mirror display system, the half-mirror display system includes a half-mirror, one or more camera, a recognition terminal, a processor and a monitor display, the method comprising:
operating the camera to capture a stream of images from in front of the half-mirror;
operating the recognition terminal to detect a product and product orientations in the stream of images;
operating the processor to augment reflection of the product in the half-mirror with Meta-data of the product in real time; and
displaying the Meta-data of the product on the monitor display,
wherein the half-mirror continues to function as a mirror and the monitor display displaying meta-data through the half-mirror and overriding the refection in part and thereby augmenting the reflection.

8. A half-mirror display system, comprising:
a half-mirror;
at least one camera for capturing a stream of images from in front of the half-mirror;
a recognition terminal to detect product and product orientations in the stream of images;
a processor to augment reflection of the product in the half-mirror based on eye position and position of a user with Meta-data of the product in real time; and
a monitor for displaying the Meta-data of the product,
wherein the half-mirror continues to function as a mirror and the monitor display displaying meta-data through the half-mirror and overriding the refection in part and thereby augmenting the reflection.

9. The system of claim 8, wherein the camera is configured to capture a stream of images including a user and the product being visible from in front of the half-mirror.

10. The system of claim 8, wherein the camera is for capturing the stream of images from in front of the half-mirror or near position of the half-mirror, where the presence of the user is detected by a sensor.

11. The system of claim 8, wherein the camera may be configured with user motion detection sensor.

12. The system of claim 8, wherein the recognition terminal is communicatively coupled to a processor and monitor display, the recognition terminal further comprising: a detection module configured to detect the product in the images captured by the camera, the detection module further configured to retrieve Meta-data that is detailed product information from a product database, stock keeping unit (SKU) or store inventory.

13. The system of claim 8, wherein the processor is to augment reflection with Meta-data of the product and display the augmented reflection for augmented reality display.

14. The system of claim 8, the processor is configured to augment reflection by overlaying with Meta-data of the product and displaying Meta-data in real time on the monitor display.

15. The system of claim 8, wherein the Meta-data includes detailed product information including but not limited to a brand, a description of the product, a price, or a category of the products.

16. (canceled)
